(19) United States
(12) Patent Application Publication
(10) Pub. No.: US 2003/0070921 A1
(43) Pub. Date: Apr. 17, 2003

(54) Sensor, electrode, and methods of making and using the same

(76) Inventors: Eric P. Clyde, Bay City, MI (US); Kailash C. Jain, Troy, MI (US); Paul C. Kikuchi, Fenton, MI (US)

Correspondence Address: Vincent A. Cichosz, Delphi Technologies, Inc., M/C 480-410-202, P.O. Box 5052, Troy, MI, 48007, US

(21) Appl. No.: 10/269,442

(22) Filed: Oct. 11, 2002

Related U.S. Application Data
(60) Provisional application No. 60/328,687, filed on Oct. 11, 2001.

(51) Int. Cl. C25B 11/04; C25D 3/38; G01N 27/26; C22C 5/04

(52) U.S. Cl. 204/291; 204/421; 205/292; 420/466

(57) ABSTRACT

Disclosed herein are electrodes, sensors, and methods for making and using the same. In one embodiment, the sensor comprises: a co-fired sensing electrode comprising the reaction product of about 50 wt % to about 95 wt % noble metal, about 0.5 wt % to about 15.0 wt % yttria-stabilized zirconia, and about 1 wt % to about 6 wt % yttria, based upon a total combined weight of the noble metal, yttria-stabilized zirconia, and yttria, a reference electrode, and a co-fired electrolyte disposed between and in ionic communication with the co-fired sensing electrode and the reference electrode.

In one embodiment, the method of making the sensor comprises: forming an ink comprising about 50 wt % to about 95 wt % metal component, about 0.5 wt % to about 15 wt % yttria-stabilized zirconia, about 1 wt % to about 6 wt % yttria, and solvent, wherein the weight percentages are based on a total weight of non-solubles the ink, applying the ink to at least a portion of a first side of an electrolyte to form an assembly, and co-firing the assembly to form the sensor.

### CROSS REFERENCE TO RELATED APPLICATION

This application claims the benefit of U.S. Provisional Application Serial No. 60/328,687 filed Oct. 11, 2001, which is incorporated herein by reference.

### BACKGROUND

Exhaust sensors are used in the automotive industry to sense the composition of exhaust gases such as oxygen, hydrocarbons, and oxides of nitrogen, with oxygen sensors measuring the amounts of oxygen present in exhaust gases relative to a reference gas, such as air. A switch type oxygen sensor, typically, comprises an ionically conductive solid electrolyte material, a sensing electrode that is exposed to the exhaust gas, and a reference electrode that is exposed to the reference gas. It operates in potentiometric mode, where oxygen partial pressure differences between the exhaust gas and reference gas on opposing faces of the electrochemical cell develop an electromotive force, which can be described by the Nernst equation:

$$E = ( \frac{R T}{4 F} ) ln ( \frac{{P}_{{O}_{2}}^{ref}}{{P}_{{O}_{2}}} )$$

where:

E=electromotive force

R=universal gas constant

F=Faraday constant

T=absolute temperature of the gas

P_{O}_{₂}^{ref}=oxygen partial pressure of the reference gas

P_{O}_{₂}=oxygen partial pressure of the exhaust gas

The large oxygen partial pressure difference between rich and lean exhaust gas conditions creates a step-like difference in cell output at the stoichiometric point; the switch-like behavior of the sensor enables engine combustion control about stoichiometry. Stoichiometric exhaust gas, which contains unburned hydrocarbons, carbon monoxide, and oxides of nitrogen, can be converted very efficiently to water, carbon dioxide, and nitrogen by automotive three-way catalysts in automotive catalytic converters. In addition to their value for emissions control, the sensors also provide improved fuel economy and drivability.

Further, control of engine combustion can be obtained using amperometric mode exhaust sensors, where oxygen is electrochemically pumped through an electrochemical cell using an applied voltage. A gas diffusion-limiting barrier creates a current limited output, the level of which is proportional to the oxygen content of the exhaust gas. These sensors typically consist of two or more electrochemical cells; one of these cells operates in potentiometric mode and serves as a reference cell, while another operates in amperometric mode and serves as an oxygen-pumping cell. This type of sensor, known as a wide range, lambda, or linear air/fuel ratio sensor, provides information beyond whether the exhaust gas is qualitatively rich or lean; it can quantitatively measure the air/fuel ratio of the exhaust gas.

The solid electrolyte commonly used in exhaust sensors is yttria-stabilized zirconia, which is an excellent oxygen ion conductor. The electrodes are typically platinum-based and porous in structure to enable oxygen ion exchange at electrode/electrolyte/gas interfaces. These platinum electrodes may be co-fired or applied to a fired (densified) electrolyte element in a secondary process, such as sputtering, plating, dip coating, etc. These electrodes can be made in the form of a film, paste, or ink and applied to the solid ceramic electrolyte in several ways. The ink is added either before the ceramic is fired (green), before the ceramic is fully fired (bisque) or after the ceramic is fully fired.

Oxygen sensors, during operations, are subjected to varying conditions such as temperatures ranging from ambient temperatures, when the engine has not been recently run, to higher than 1,000° C. during operation. Certain properties of the sensor may be affected by the varying conditions including electrical parameters, namely voltage amplitude, response times, switching characteristics, and light-off times. As such, stable and reproducible performance of a sensor is desirable.

### SUMMARY

Disclosed herein is a sensor, and methods for making and using the same. In one embodiment, the sensor comprises: a co-fired sensing electrode comprising the reaction product of about 50 wt % to about 95 wt % noble metal, about 0.5 wt % to about 15.0 wt % yttria-stabilized zirconia, and about 1 wt % to about 6 wt % yttria, based upon a total combined weight of the noble metal, yttria-stabilized zirconia, and yttria, a reference electrode, and a co-fired electrolyte disposed between and in ionic communication with the co-fired sensing electrode and the reference electrode.

In another embodiment, the sensor comprises: a co-fired sensing electrode comprising about 88 wt % to about 95.5 wt % noble metal, about 4.5 wt % to about 12.0 wt % yttria-stabilized zirconia, based upon the total weight of the co-fired sensing electrode, and yttria disposed on walls of a platinum pore network, a reference electrode, and a co-fired electrolyte disposed between and in ionic communication with the co-fired sensing electrode and the reference electrode.

In one embodiment, the method of making the sensor comprises: forming an ink comprising about 50 wt % to about 95 wt % metal component, about 0.5 wt % to about 15 wt % yttria-stabilized zirconia, about 1 wt % to about 6 wt % yttria, and solvent, wherein the weight percentages are based on a total weight of non-solubles the ink, applying the ink to at least a portion of a first side of an electrolyte to form an assembly, and co-firing the assembly to form the sensor.

In one embodiment, the electrode comprises the reaction product of: about 50 wt % to about 95 wt % metal component having particles having a median particle diameter of about 0.1 micrometers to about 1 micrometer, about 0.5 wt % to about 15.0 wt % yttria-stabilized zirconia having particles having a median particle diameter of about 0.1 micrometers to about 1 micrometer, and about 1 wt % to about 6 wt % yttria having particles having a median particle diameter of about 0.1 micrometers to about 3 micrometers.

In one embodiment, the method of sensing exhaust gas comprises: contacting a sensing electrode of a sensor with exhaust gas, wherein the sensor comprises a co-fired sensing electrode comprising about 88 wt % to about 95.5 wt % noble metal, about 4.5 wt % to about 12.0 wt % yttria-stabilized zirconia, based upon the total weight of the co-fired sensing electrode, and yttria disposed on walls of a noble metal pore network, a reference electrode, and a co-fired electrolyte disposed between and in ionic communication with the co-fired sensing electrode and the reference electrode.

The above-described and other features will be appreciated and understood by those skilled in the art from the following detailed description, drawings, and appended claims.

### BRIEF DESCRIPTION OF THE DRAWINGS

Referring now to the figures wherein the like elements are numbered alike.

FIG. 1 is a schematic of one embodiment of a conical oxygen sensor cross section.

FIG. 2 is a scanning electron micrograph (SEM) of pure platinum (at least 99.95% pure) ink electrode co-fired at 1,510° C. on conical oxygen sensor.

FIG. 3 is a SEM of platinum ink electrode with 0.75 wt % partially stabilized zirconia (with 3 mole percent yttria) and 2 wt % carbon black co-fired at 1,510° C. on conical oxygen sensor.

FIG. 4 is a SEM of platinum ink electrode with 2 wt % fully stabilized zirconia (with 8 mole percent yttria) co-fired at 1,510° C. on conical oxygen sensor.

FIG. 5 is a SEM of platinum ink with 4 wt % fully stabilized zirconia, 1 wt % carbon black, and 4 wt % yttria, co-fired at 1,510° C. on conical oxygen sensor.

FIG. 6 is a plot showing engine test static lambda switching curves for various ink formulations.

### DETAILED DESCRIPTION

A sensor comprises a sensing electrode and a reference electrode with an electrolyte disposed there between. Disposed in thermal communication with the electrodes is an optional heater, with leads in electrical communication with the electrodes and the heater. The sensor can be conical or planar and can be employed to sense oxygen, nitrogen oxides, hydrogen, hydrocarbons, and the like, depending upon the electrodes employed.

Electrolyte layer, which is preferably a solid electrolyte that can comprise the entire layer or a portion thereof, can be any material that is capable of permitting the electrochemical transfer of oxygen ions while inhibiting the physical passage of exhaust gases, has an ionic/total conductivity ratio of approximately unity, and is compatible with the environment in which sensor element will be utilized (e.g., up to about 1,000° C.). Possible solid electrolyte materials can comprise metal oxides such as zirconia, and the like, which may optionally be stabilized with calcium, barium, yttrium, magnesium, aluminum, lanthanum, cesium, gadolinium, and the like, and oxides thereof, as well as combinations comprising at least one of the foregoing electrolyte materials. For example, the electrolyte can be alumina-yttrium stabilized zirconia, yttria-stabilized zirconia, ceria, strontium-cerium oxide, barium cerium oxide, strontium cerium zirconates, barium cerium zirconates, and the like. Typically, the electrolyte, which can be formed by, for example, die pressing, roll compaction, stenciling and screen printing, tape casting techniques, and the like, has a thickness of about 10 to about 500 micrometers, with a thickness of approximately 25 micrometers to about 500 micrometers preferred, and a thickness of about 50 micrometers to about 200 micrometers especially preferred.

At least one, preferably both of the electrode(s) disposed on or adjacent to the electrolyte are multi-component compositions. These electrodes comprise a metal component, a first ceramic component, and a second ceramic component, with a fugitive material also preferably present prior to sintering. The particular metal component is dependent upon the type of gas to be sensed. Typically, metals such as platinum, palladium, gold, osmium, rhodium, iridium, ruthenium, and the like, as well as alloys, oxides, and combinations comprising at least one of the foregoing metals, can be employed.

The metal component can be present in an amount sufficient to attain the desired catalytic activity of the electrode. Typically, the metal component is present in an amount of about 50 wt % to about 95 wt %, with the weight based upon the total weight of the non-solubles in the electrode ink (e.g., the weight of the electrode prior to sintering, excluding the weight of the solvent and any vehicles (e.g., acetone or other soluble organic materials)). Within this range, the amount of metal component can be greater than or equal to about 55 wt %, with greater than or equal to about 75 wt % preferred. Also preferred within this range is an amount of metal component of less than or equal to about 90 w %, with less than or equal to about 85 wt % more preferred. All weights described herein refer to the total weight of the non-solubles in the electrode composition, prior to sintering, unless otherwise noted.

The first ceramic component preferably comprises the same material employed in electrolyte in order to promote bonding between electrode and the electrolyte. Possible first ceramic components include alumina, zirconia, yttria, ceria, strontia, barium cerium oxide, strontium cerium zirconates, barium cerium zirconates, lanthana, magnesia, scandia, and the like, and mixtures comprising at least one of the foregoing first ceramic components, including yttria-zirconia, yttria-alumina, scandia-zirconia, scandia-alumina, yttria-alumina-zirconia, scandia-alumina-zirconia, and the like. Preferably, the first ceramic component comprises yttria-stabilized zirconia (e.g., zirconia stabilized with about 3 mole percent (mol %) to about 8 mol % yttria, based upon the total weight of the yttria-stabilized zirconia), such as fully yttria-stabilized zirconia (i.e., zirconia stabilized with about 8 mol % yttria, based upon the total weight of the yttria-stabilized zirconia) and/or partially yttria-stabilized zirconia ((i.e., zirconia stabilized with less than 8 mol % yttria), about 3 mol % to about 5 mol % yttria is preferred, based upon the total weight of the yttria-stabilized zirconia); partially yttria stabilized zirconia is more preferred. The particles of the first ceramic component preferably have a median diameter (that is, about 50% of the particles have a larger diameter and about 50% of the particles have a smaller diameter) of about 0.1 micrometers to about 1 micrometer, with 0.3 micrometers to about 0.7 micrometers preferred. As used herein, unless otherwise noted, all particle diameters refer to the median particle diameter measured along a major axis (i.e., the longest axis) of the particle.

The first ceramic component can be present in an amount sufficient to bond the electrode to the electrolyte. Typically, the first ceramic component can be present in an amount of about 0.50 wt % to about 15 wt %, based upon the total weight of the electrode. Within this range, the amount of first ceramic component can be greater than or equal to about 1 wt %, with greater than or equal to about 4.5 wt % preferred. Also preferred within this range is an amount of first ceramic component of less than or equal to about 13 w % with less than or equal to about 12 wt % more preferred.

The second ceramic component comprises any ceramic material that can inhibit sintering of the metal component. It is advantageous to select a second ceramic that will have a synergetic effect with the electrolyte and/or the first ceramic component. Preferably, the second ceramic component comprises yttria. It should be noted, that this yttria is different from the yttria in the first ceramic component in that it is introduced to the ink as yttrium oxide and is not, therefore, disposed in the zirconia crystalline structure or otherwise bound within another crystalline structure; as is well understood by those skilled in the art, yttrium oxide is an entirely different substance than yttria stabilized zirconia. Without being bound to theory, the yttria reacts with the metal, e.g., platinum, to form a pyrochlore-type yttria rich surface phase that is catalytic. Further, this surface reaction with platinum lowers the overall surface energy of the electrode-electrolyte system, thereby reducing the driving force for sintering of the electrode system. Yttria addition, therefore, stabilizes the open pore network (e.g., the metal component pore network), enabling proper sensor function. For example, the final, formed electrode can comprise about 88 wt % to about 95.5 wt % noble metal (preferably platinum), about 4.5 wt % to about 12.0 wt % yttria-stabilized zirconia, based upon the total weight of the co-fired sensing electrode, and yttria disposed on walls of a noble metal pore network.

The yttria particles preferably have a median diameter of about 0.1 micrometer to about 3 micrometers. Within this range, the yttria preferably has a diameter of greater than or equal to about 1.0 micrometer, with greater than or equal to about 1.3 micrometers more preferred. Also preferred within this range is a diameter of less than or equal to about 2.0 micrometers, with less than or equal to about 1.7 micrometers more preferred.

The second ceramic component can be present in an amount of about 1 wt % to about 6 wt %, based upon the total weight of the electrode non-solubles prior to calcination. Within this range, the amount of second ceramic component can be greater than or equal to about 1.5 wt %, with greater than or equal to about 2 wt % preferred. Also preferred within this range is an amount of second ceramic component of less than or equal to about 5 wt %, with less than or equal to about 4 wt % more preferred.

The fugitive material can include any material that is removed during the sintering process (e.g., bums off, volatilizes, etc.). Some possible fugitive materials include graphite, carbon black, starch, nylon, polystyrene, latex, and the like, with latex spheres preferred and carbon black more preferred. The particle size of the fugitive material is determined by the desired pore size of the sintered electrode. Preferably, the fugitive material may have particles having a diameter of about 0.1 micrometers to about 2.0 micrometers, with a median agglomerate major diameter of less than or equal to about 15 micrometers. Within this range, a diameter of greater than or equal to about 0.2 is preferred, with greater than about 0.3 more preferred. Also preferred within this range is a diameter of less than or equal to about 1.5 micrometers, with less than or equal to about 1.0 micrometers more preferred.

The fugitive material can be present in an amount of about 0.1 wt % to about 5 wt %. Within this range, the amount of fugitive material can be greater than or equal to about 0.15 wt %, with greater than or equal to about 0.25 wt % preferred. Also preferred within this range is an amount of fugitive material of less than or equal to about 4 w % with less than or equal to about 3 wt % more preferred.

The electrodes can be prepared by forming an ink, paste, slurring, or extrudate of the electrode materials, i.e., combining the metal component, first ceramic component, second ceramic component, and fugitive material with a solvent. The ink can then be formed into the electrode by any appropriate method, such as chemical vapor deposition, screen printing, sputtering, and stenciling, among others. For example, the metal component (e.g., platinum) and the first ceramic component (e.g., fully or partially ytrria-stabilized zirconia) can be wet ball milled prior to mixing a fugitive material therewith. Then, the second ceramic component (e.g., yttria) can be added to the mixture and the mixture can be milled (e.g., three-roll-milled) or otherwise mixed to produce a homogeneous ink, slurry, paste, or the like. Although the components can be combined in any order, it is preferred that the second ceramic component be added last and three-roll milled to retain the size and integrity of the second ceramic component particles while thoroughly mixing the components. The resulting ink may be adjusted for use as a screen print ink or pad print ink for use in producing planar sensors, or further diluted to a suspension for producing a slip-cast electrode on conical sensors. Consequently, the ink may further comprise sufficient solvent to attain the desired consistency for the chosen electrode formation technique, e.g., typically about 9 wt % to about 48.5 wt % solvents and/or organics (e.g., vehicles), based upon the total weight of the ink are employed, although other amounts can be used.

Once prepared, the ink can be applied to the desired area of the sensor, typically the electrolyte (thus forming sensing electrode and reference electrode). Once the ink has been applied, the electrodes may be dried, passively and/or actively, e.g., air dried in a convection oven at about 80° C. to about 100° C. for up to about 10 minutes. Finally, the electrode(s) and electrolyte are co-fired to a sufficient temperature and for a sufficient period of time to sinter the electrolyte and reduce the metal component to its catalytically active form. Generally, the co-firing is performed at temperatures of about 1,475° C. to about 1,550° C., with a temperature of about 1,500° C. to about 1,520° C. preferred, at atmospheric pressure. The duration of the sintering operation typically varies from about 1 to about 5 hours at the maximum temperature depending upon the combination of materials and the sintering temperature. The resulting electrode, that is, the reaction product of the noble metal compound, the first ceramic compound and the second ceramic compound, preferably comprises about 92 wt % to about 94 wt % noble metal, about 6 wt % to about 8.0 wt % ceramic phase consisting of partially and fully yttria-stabilized zirconia.

Optionally, once co-fired, the electrode(s) may be subjected to an activation treatment to improve the voltage output and to reduce the internal resistance of the sensor element, when compared to untreated electrode(s). Activation treatment can, for example, comprise placing the electrode(s) in contact with a solution or combination of solutions of an inorganic acid, an acid salt, various alkaline solutions, and the like. Aqueous solutions of an inorganic acid, such as hydrochloric acid, sulfuric acid, nitric acid, phosphoric acid, hydrofluoric acid, and chloroplatinic acid are generally preferred, while acid salts may include ammonium chloride, hydroxylamine hydrochloride, ammonium chloroplatinate, and the like. Possible alkaline solutions include potassium hydroxide, lithium hydroxide, cesium hydroxide, sodium hydroxide, and the like.

After the optional activation treatment, a coating(s) can optionally be disposed over at least a portion of the sensing electrode, e.g., protective coating that may be a porous diffusion restrictive coating. Suitable protective coating(s) may comprise spinel (e.g., magnesium aluminate), alumina, zirconia, and the like, as well as combinations comprising at least one of the foregoing, with fugitive materials optionally present during formation of the protective coating. If a second protective coating is employed over a first protective coating, the second protective coating preferably comprises alumina (e.g., theta-alumina, gamma-alumina, delta-alumina, and the like, as well as combinations comprising at least one of the forgoing alumina) stabilized by rare earth or alkaline earth metal oxides (such as lanthanum oxide, strontium oxide, barium oxide, calcium oxide, and the like, as well as combinations comprising at least one of the foregoing oxides).

The protective coating(s) may be disposed using thin or thick film deposition techniques including sputtering, electron beam evaporation, chemical vapor deposition, screen printing, pad printing, ink jet printing, spinning, spraying, including flame spraying and plasma spraying, dip-coating, and the like, of which dip-coating is typically preferred for protective coatings on conical sensors. This protective coating typically has a thickness of about 10 micrometers to about 500 micrometers, with about 10 micrometers to about 400 micrometers preferred.

In addition to the electrodes, electrolyte, and protective coating(s), the sensor may further comprise a heater (not shown) disposed in thermal communication with at least the reference electrode and preferably both electrodes. Generally, the heater comprises a metal (e.g., platinum, aluminum, palladium, and the like), and/or metal oxides (such as alumina and the like), as well as alloys and combinations comprising at least one of the foregoing.

In operation, the reference electrode is exposed to a reference gas, such as atmospheric air, stored oxygen, or the like, while sensing electrode is exposed to a sensing atmosphere, such as automotive exhaust gas. The electromotive force (EMF) measured between the sensing and reference electrodes, due to the galvanic potential, which represents the partial pressure differences between the sensing atmosphere and the reference gas, can be used to determine the concentration of oxygen in the sensing atmosphere.

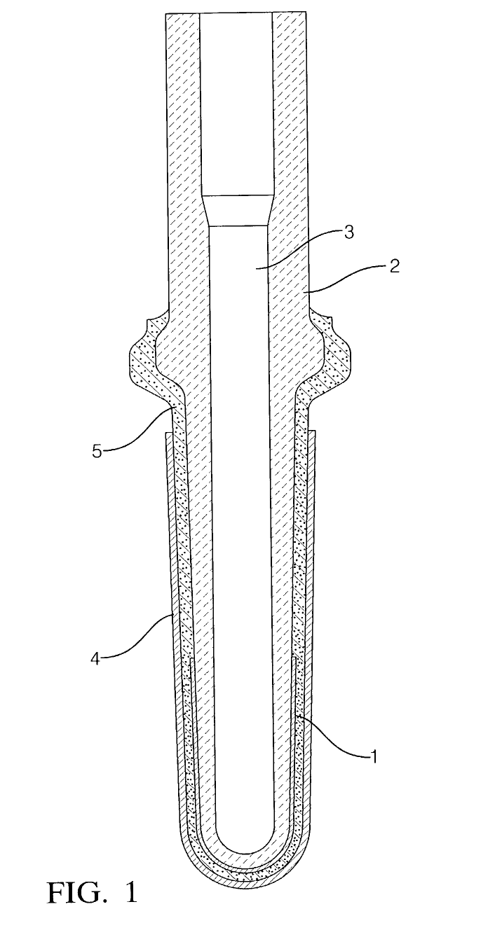

Referring now to FIG. 1, a schematic of a cross-sectional view of one embodiment of a conical sensor is illustrated. Oxygen sensor comprises a sensing electrode 1, electrolyte 2, reference electrode 3, a protective coating 4 (second protective coating), and diffusion restriction porous coating 5 (first protective coating). Sensing electrode 1 is disposed on a first side of electrolyte 2, and reference electrode 3 is disposed on second side of electrolyte 2, i.e., on the surface opposed to the surface having sensing electrode 1. Protective coating 4 substantially covers sensing electrode I, while the diffusion restriction porous coating 5 covers at least the portion of the protective coating 4 disposed over the sensing electrode 1.

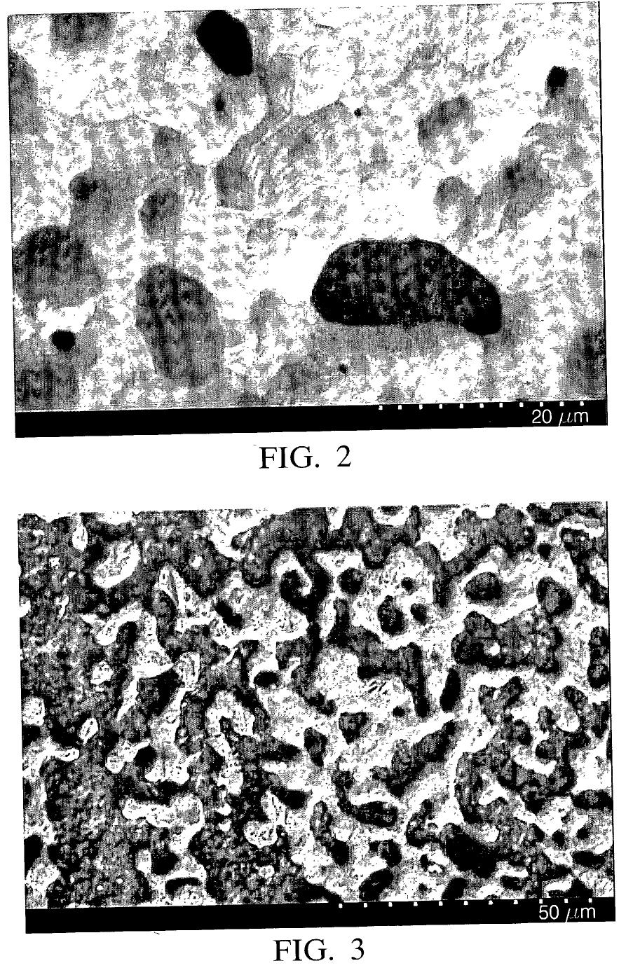

In FIGS. 2-5, scanning electron micrographs (SEMs) sensing electrodes on conical oxygen sensors are illustrated, where the sensing electrode and electrolyte have been co-fired at 1,510° C. In FIG. 2, a SEM for a platinum ink electrode is shown (e.g., comprising an about 99.95% pure platinum electrode; no ceramics in the electrode). The lightest (white) particles are platinum, the largest black area is a hole, and the smaller black particles are dis-colored platinum grains. As can be seen in this micrograph, the median platinum particle diameter is about 4 micrometers. There is generally no disruption of the platinum sheet. When this electrode was tested for catalytic activity (i.e., the temperature at which an output change of greater than or equal to 300 millivolts is observed upon switching from lean to rich), it was determined that an exhaust temperature of greater than 600° C. is needed to demonstrate catalytic activity.

Referring now to FIG. 3, a SEM is shown for a platinum ink electrode having 0.75 wt % partially yttria-stabilized zirconia (3 mol % yttria), and 2 wt % carbon black, balance platinum, based upon the total weight of non-solubles in the ink. As can be seen from the micrograph, the median platinum particle diameter is about 2 to about 3 micrometers. The surface area of this electrode is reduced as compared to the electrode of FIG. 2 (i.e., a surface area of 95% versus 35%) due to coalescence of platinum during co-firing. Additionally, this electrode also requires greater than 600° C. exhaust temperature to demonstrate catalytic activity.

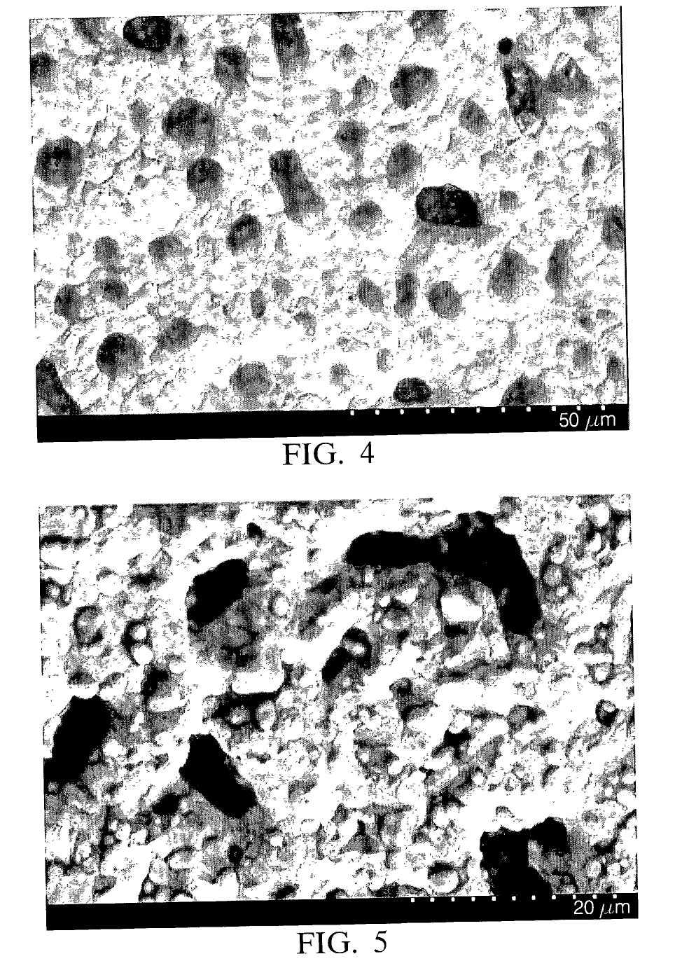

Referring now to FIG. 4, a SEM is shown for a platinum ink electrode having 2 wt % carbon black, 0.75 wt % fully yttria-stabilized zirconia (8 mol % yttria), balance platinum, with the weight percentage based on total weight of electrode. As can be seen from the micrograph, the median platinum particle diameter is about 3 to about 4 micrometers. These large grains, which lack of finely distributed porosity, also render this electrode morphology unsatisfactory for sensor performance; e.g., a catalytic activity below an exhaust temperature of 600° C.

Referring now to FIG. 5, a SEM is shown for a platinum ink electrode having 4 wt % fully yttria-stabilized zirconia, 1 wt % carbon black, and 4 wt % yttria, balance platinum, with the weight percentages based on total weight of non-solubles in the ink. As can be seen from the micrograph, the median platinum particle diameter is about 0.2 to about 2.0 micrometers. Also there are very fine Pt particles in the mushroom type of grains. As the yttria particles wet the surface of platinum the overall surface energy of the electrode system is reduced, thereby the driving force for sintering of the porous platinum network is reduced. This structure has fine grains, distributed porosity, a considerable surface area for catalysis. In other words, this electrode has a catalytic activity at exhaust temperatures of 400° C. without activation treatment. With activation treatment, e.g., dipping in an alkaline solution, catalytic activity is observed at exhaust temperatures as low as about 370° C. (tested). It is believe that activity starts at about 350° C.

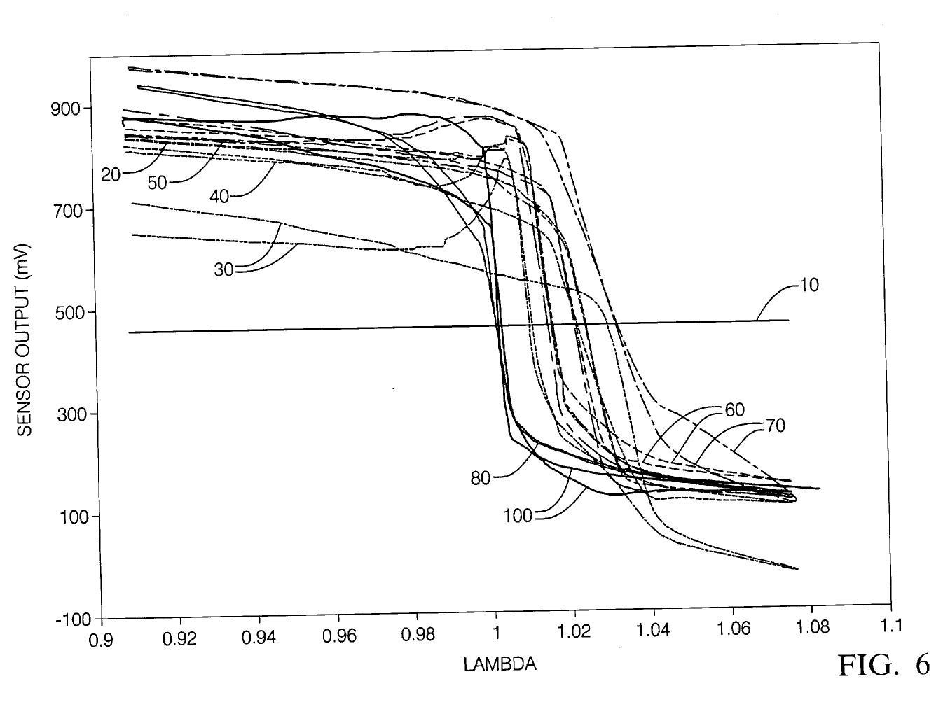

Referring now to FIG. 6, a graphical plot is shown for engine test results from conical sensors made with various sensing electrode ink. Nine platinum ink compositions were created using the above-mentioned approach and combination of materials. The electrodes were compared to a sputter electrode (100) comprising pure platinum with a lead conditioning treatment. The test is a sweep of air-fuel ratios from rich (0.91 lambda) to lean (1.08 lambda) and returning to rich at an exhaust gas temperature of 400° C. on a 3.8L V6 engine. Electromotive force (EMF) is plotted as function of lambda (i.e., the stoichiometric air/fuel ratio divided by actual air to fuel ratio). The following observations are noted. A platinum electrode (10) having no additional components has no response at this temperature. The addition of zirconia, either fully (20) or partially (30) yttria stabilized, improves the response of the electrode being tested, however the total responsive voltage amplitude (total difference between rich voltage and lean voltage) is inadequate for engine control. Fully yttria-stabilized zirconia (20) yields better voltage amplitudes, when compared to partially yttria-stabilized zirconia (30). The addition of a fugitive material slightly improves the response of the electrode with partially yttria-stabilized zirconia (40), but has no noticeable effect on the electrode made with fully yttria-stabilized zirconia (50). The addition of yttria improves the amplitude of response and reduces the amount of hysteresis (the difference between the rich to lean transition curve and the lean to rich transition curve; partially yttria-stabilized zirconia with yttria (60); fully yttria-stabilized zirconia with yttria (70)). Moreover, the platinum electrode with fully yttria-stabilized zirconia and additional yttria shows the best amplitude and the least hysteresis of all compositions shown.

Generally, a good sensor comprises no hystersis (the graph of lean to rich is the same as the graph of rich to lean), the switch point from rich to lean (and lean to rich) is at lambda 1.0 with a minimal slope (i.e., the drop from the high rich voltage to the low lean voltage is as vertical as possible), and the heated rich voltage is greater than about 800 millivolts (mV) and the heated lean voltage is less than about 150 mV. The sensor disclosed herein meets these characteristics, even without an activation treatment. Electrodes of the sensor are bonded virtually inseparably to the electrolyte, providing high thermal, mechanical, and corrosion stability. The sensor has an unheated high rich voltage output (e.g., greater than or equal to about 800 mV at lambda of less than about 0.98) and an unheated low lean voltage (e.g., less than or equal to about 150 mV at lambda of greater than about 1.02), without an activation treatment, at 400° C. exhaust gas temperature, and without a heater. This sensor has a service life exceeding 100,000 miles and short light-off times, e.g., about 10 to about 15 seconds or less. An additional advantage of this sensor relates to the switching times, i.e., the time it takes the sensor to switch from lean (lambda of 1.02) to rich (lambda of 0.98) and from rich to lean. In sensors that do not comprise the yttria as disclosed herein, switching times for unheated sensors are 100 milliseconds (msec) to 300 msec or so, with switching times for heated sensors being 30 msec to 80 msec. In contrast, this sensor (comprising the yttria in the ink) has a switch time for an unheated sensor of less than 100 msec, with a switching time for the heated sensor (e.g., an electrode temperature of greater than about 600° C.) being less than or equal to about 20 msec, typically about 8 msec to about 12 msec or even less (i.e., even as a conical sensor, this sensor approaches the switching times attained with planar sensors; virtually instantaneous).

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A sensor, comprising:
a co-fired sensing electrode comprising the reaction product of about 50 wt % to about 95 wt % noble metal, about 0.5 wt % to about 15.0 wt % yttria-stabilized zirconia, and about 1 wt % to about 6 wt % yttria, based upon a total combined weight of the noble metal, yttria-stabilized zirconia, and yttria;
a reference electrode; and
a co-fired electrolyte disposed between and in ionic communication with the co-fired sensing electrode and the reference electrode.

2. The sensor according to claim 1, wherein the yttria-stabilized zirconia comprises about 3 mol % to about 8 mol % yttria disposed in the zirconia crystalline structure.

3. The sensor according to claim 2, wherein the yttria-stabilized zirconia comprises about 5 mol % to about 8 mol % of the yttria.

4. The sensor according to claim 1, wherein the co-fired sensing electrode comprises about 4.5 wt % to about 12 wt % of the yttria-stabilized zirconia.

5. The sensor according to claim 1, wherein the co-fired sensing electrode comprises about 1.5 wt % to about 5 wt % of the yttria.

6. The sensor according to claim 5, wherein the co-fired sensing electrode comprises about 2 wt % to about 4 wt % of the yttria.

7. The sensor according to claim 1, wherein the yttria has particles having a median particle diameter of about 0.1 micrometers to about 3 micrometers.

8. The sensor according to claim 1, wherein the zirconia has particles having a median particle diameter of about 0.1 micrometers to about 1 micrometer.

9. The sensor according to claim 1, wherein the noble metal comprises platinum having particles having a median particle diameter of about 0.1 micrometers to about 1 micrometer.

10. The sensor according to claim 1, wherein, when heated, has a switching time of less than or equal to about 20 msec.

11. A method of making a sensor, comprising:
forming an ink comprising about 50 wt % to about 95 wt % metal component, about 0.5 wt % to about 15 wt % yttria-stabilized zirconia, about 1 wt % to about 6 wt % yttria, and solvent, wherein the weight percentages are based on a total weight of non-solubles the ink;
applying the ink to at least a portion of a first side of an electrolyte to form an assembly; and
co-firing the assembly to form the sensor.

12. The method according to claim 11, wherein the ink comprises about 1.5 wt % to about 5 wt % of the yttria.

13. The method according to claim 12, wherein the ink comprises about 2 wt % to about 4 wt % of the yttria.

14. The method according to claim 11, wherein the yttria has particles having a median particle diameter of about 0.1 micrometers to about 3 micrometers.

15. The method according to claim 11, wherein the zirconia has particles having a median particle diameter of about 0.1 micrometers to about 1 micrometer.

16. The method according to claim 11, wherein the metal component comprises platinum having particles having a median particle diameter of about 0.1 micrometers to about 1 micrometer.

17. The method according to claim 11, wherein the ink further comprises about 0.25 wt % to about 3 wt % fugitive material.

18. The method according to claim 11, wherein the sensor, when heated, has a switching time of less than or equal to about 20 msec.

19. The method according to claim 11, wherein the sensor has a rich voltage of greater than or equal to about 800 mV at lambda of less than about 0.98 and an low lean voltage of less than or equal to about 150 mV at lambda of greater than about 1.02, without an activation treatment, at 400° C. exhaust gas temperature, and without heating.

20. A sensor, comprising:
a co-fired sensing electrode comprising about 88 wt % to about 95.5 wt % noble metal, about 4.5 wt % to about 12.0 wt % yttria-stabilized zirconia, based upon the total weight of the co-fired sensing electrode, and yttria disposed on walls of a noble metal pore network;
a reference electrode; and
a co-fired electrolyte disposed between and in ionic communication with the co-fired sensing electrode and the reference electrode.

21. An electrode, comprising the reaction product of:
about 50 wt % to about 95 wt % metal component having particles having a median particle diameter of about 0.1 micrometers to about 1 micrometer;
about 0.5 wt % to about 15.0 wt % yttria-stabilized zirconia having particles having a median particle diameter of about 0.1 micrometers to about 1 micrometer; and
about 1 wt % to about 6 wt % yttria having particles having a median particle diameter of about 0.1 micrometers to about 3 micrometers.

22. A method of sensing exhaust gas, comprising:
contacting a sensing electrode of a sensor with exhaust gas, wherein the sensor comprises a co-fired sensing electrode comprising about 88 wt % to about 95.5 wt % noble metal, about 4.5 wt % to about 12.0 wt % yttria-stabilized zirconia, based upon the total weight of the co-fired sensing electrode, and yttria disposed on walls of a pore network, a reference electrode, and a co-fired electrolyte disposed between and in ionic communication with the co-fired sensing electrode and the reference electrode.
